(19) United States
(12) Patent Application Publication
(10) Pub. No.: US 2019/0317742 A1
(43) Pub. Date: Oct. 17, 2019

(54) Java Verilog Cross Compiler

(71) Applicant: Jeffrey Gregg Schoen, Fairfax, VA (US)

(72) Inventor: Jeffrey Gregg Schoen, Fairfax, VA (US)

(21) Appl. No.: 16/179,899

(22) Filed: Nov. 3, 2018

Related U.S. Application Data
(60) Provisional application No. 62/581,654, filed on Nov. 3, 2017.

(51) Int. Cl. G06F 8/41; G06F 9/455; G06F 9/38; G06F 9/30

(52) U.S. Cl. CPC G06F 8/42; G06F 8/443; G06F 9/3005; G06F 9/3877; G06F 9/30079; G06F 9/45504

(57) ABSTRACT

A method for generating code for multiple hardware platforms from a common high-level source is disclosed. The method apparatus includes a language specification, JavaVerilog, that contains the information necessary to automatically generate efficient Java, C, and SystemVerilog code for various hardware platforms. The method also includes a code generator to automatically translate the JavaVerilog code into the components necessary to configure and control the execution on the desired hardware platform. The method further defines the protocol for configuring and controlling peripheral hardware objects, such as those on a Field Programmable Gate Array (FPGA) accelerator board.

### BACKGROUND

Computer processing algorithms often have to be recoded to run on accelerators such as GPUs and FPGAs. Also, in the case of FPGA development, this usually involves lengthy compile times and slow hardware simulations. Future enhancements to these algorithms then need to be propagated to each implementation's source code. The present disclosure introduces a Code Once Run Everywhere, or CORE, programming method which uses a common code source to define an algorithm that will run on multiple hardware platforms. Each platform has inherent strengths and weaknesses with respect to developing, debugging, and deployment requirements. The physical interface to accelerator hardware is typically handled by an Open Computing Language (OpenCL) framework for GPUs or a Board Support Package (BSP) for FPGAs. The code generator can more efficienty implement this interface with direct calls where applicable.

### SUMMARY

The current version of the cross compiler, JVCC, has been used successfully in a number of projects including communications protocols, IP packet protocols, and high-speed complex modulators and demodulators. The ability to make modifications a year into an FPGA project has proved to be of great value.

### BRIEF DESCRIPTION OF THE DRAWINGS

FIG. 1 illustrates a block diagram of the disclosed programming method;

FIG. 2 depicts an example of a JavaVerilog processing core;

FIG. 3 depicts an example of the code generator's pure Java output

FIG. 4 depicts an example of the code generator's pure C output

FIG. 5 depicts an example of the code generator's pure SystemVerilog output

FIG. 6 details a description of the current code generator program JVCC

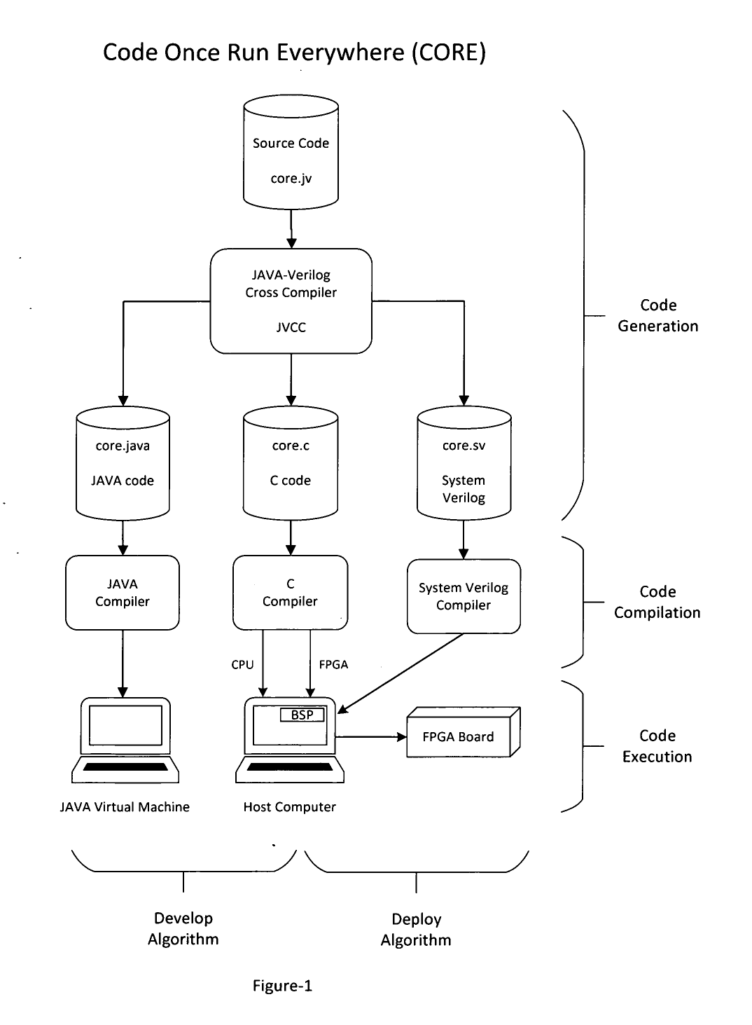

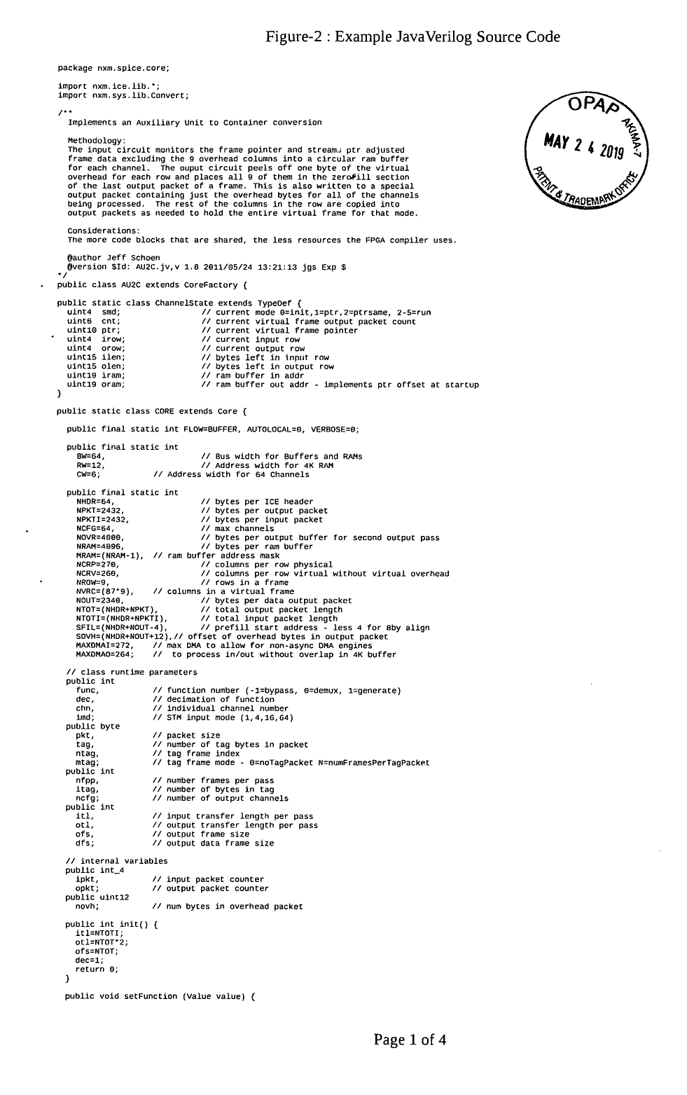

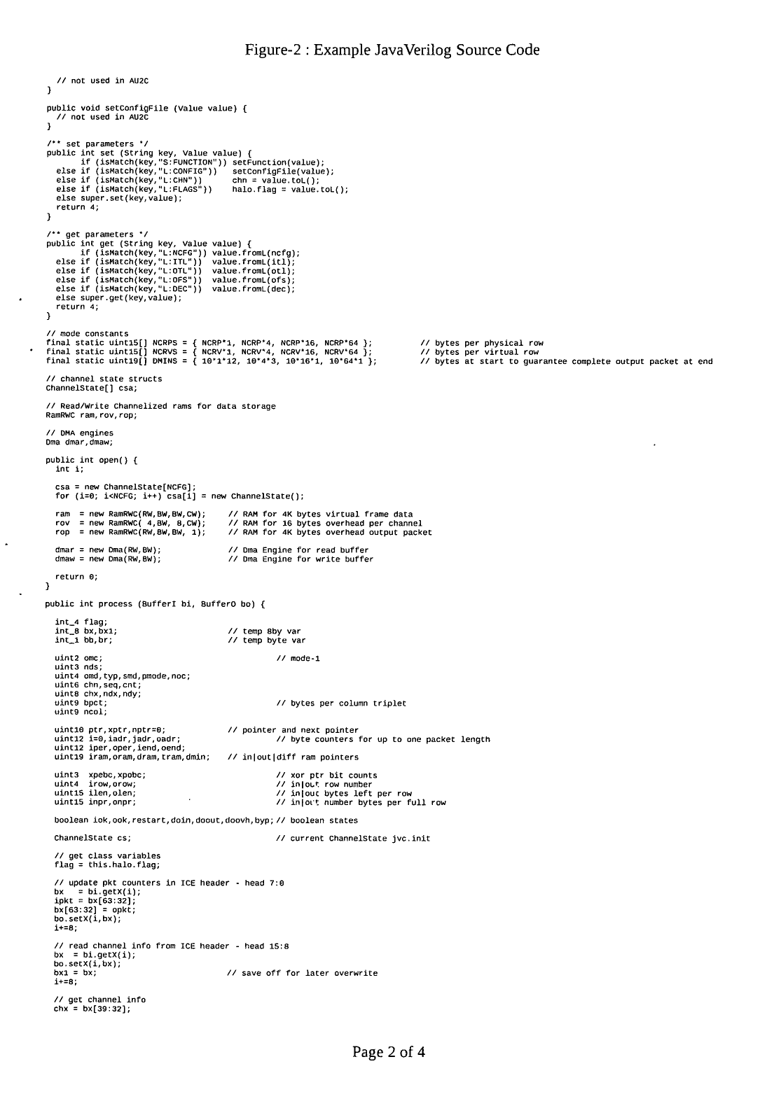

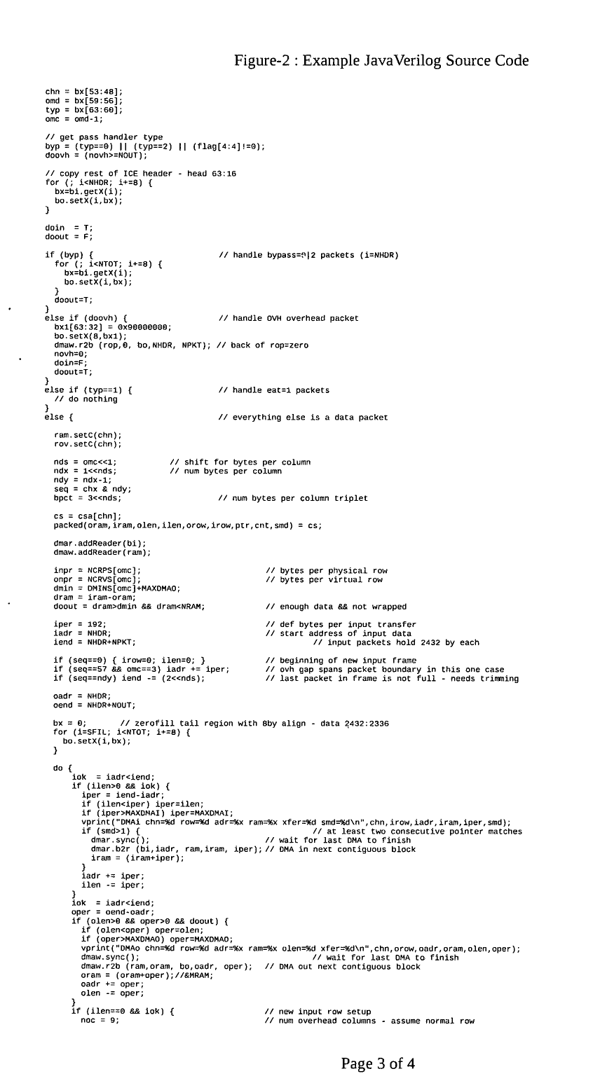

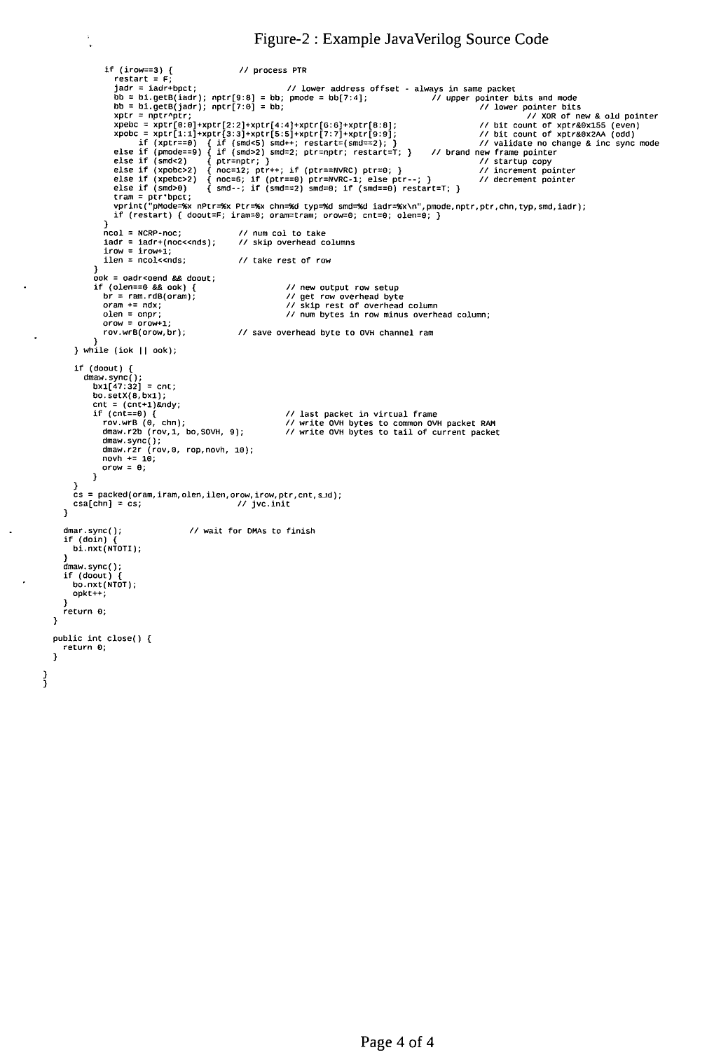

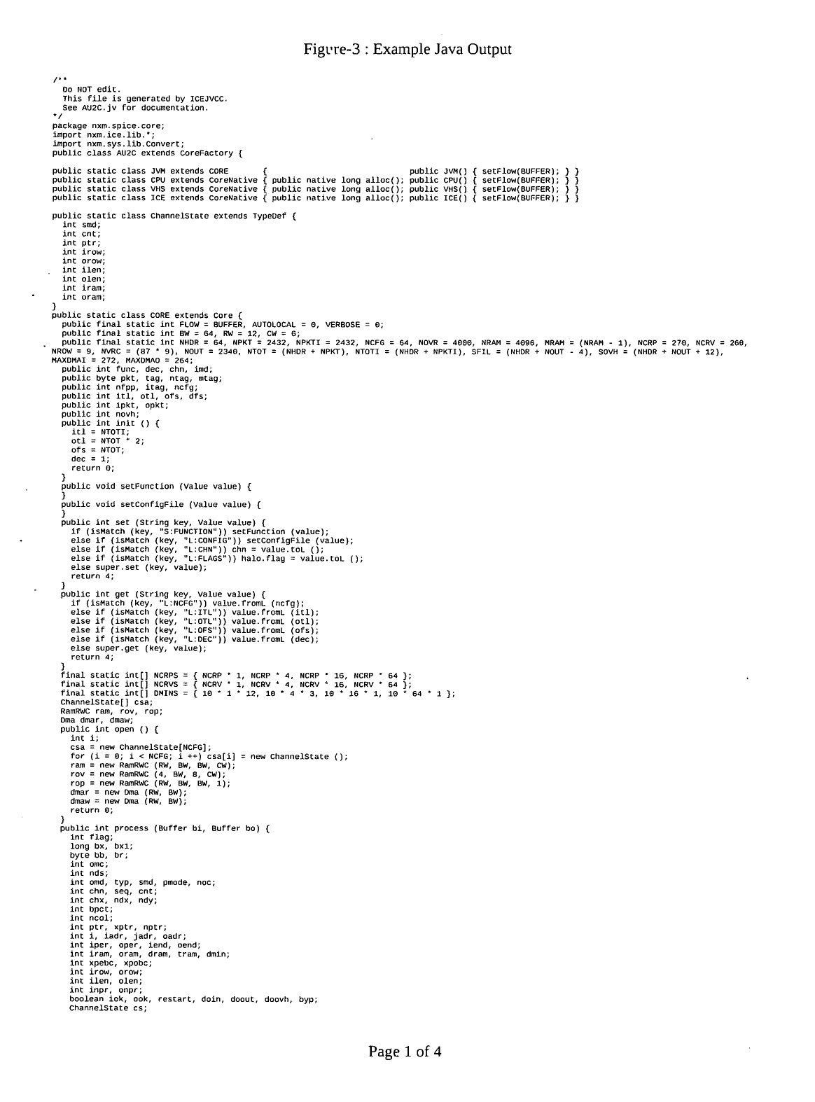

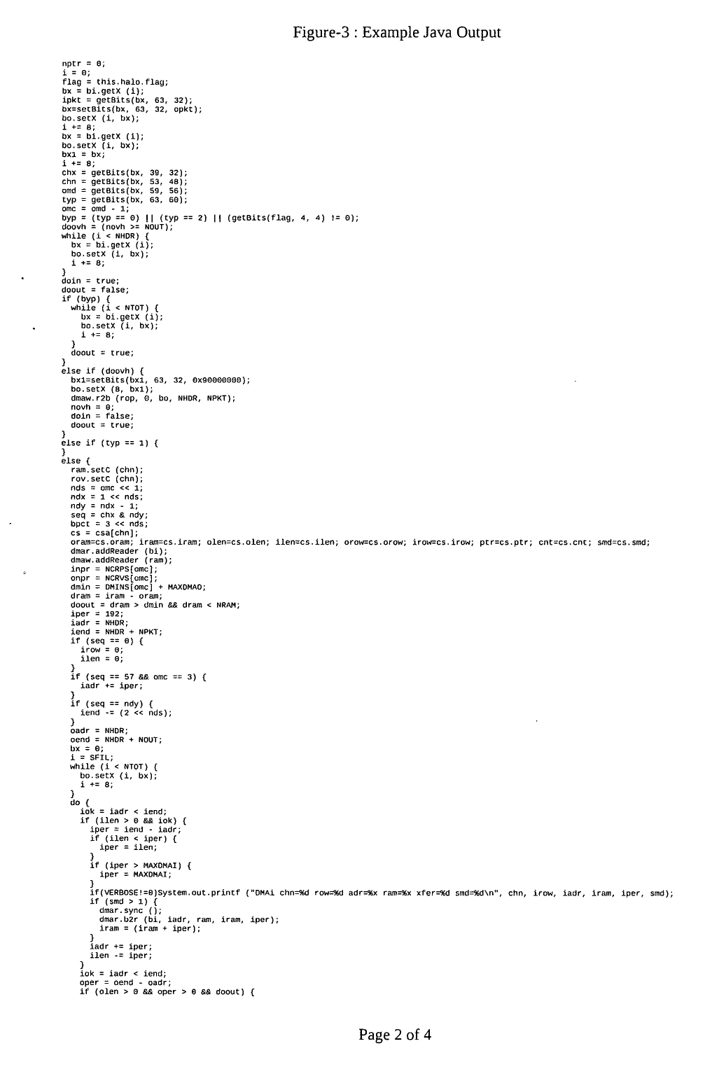

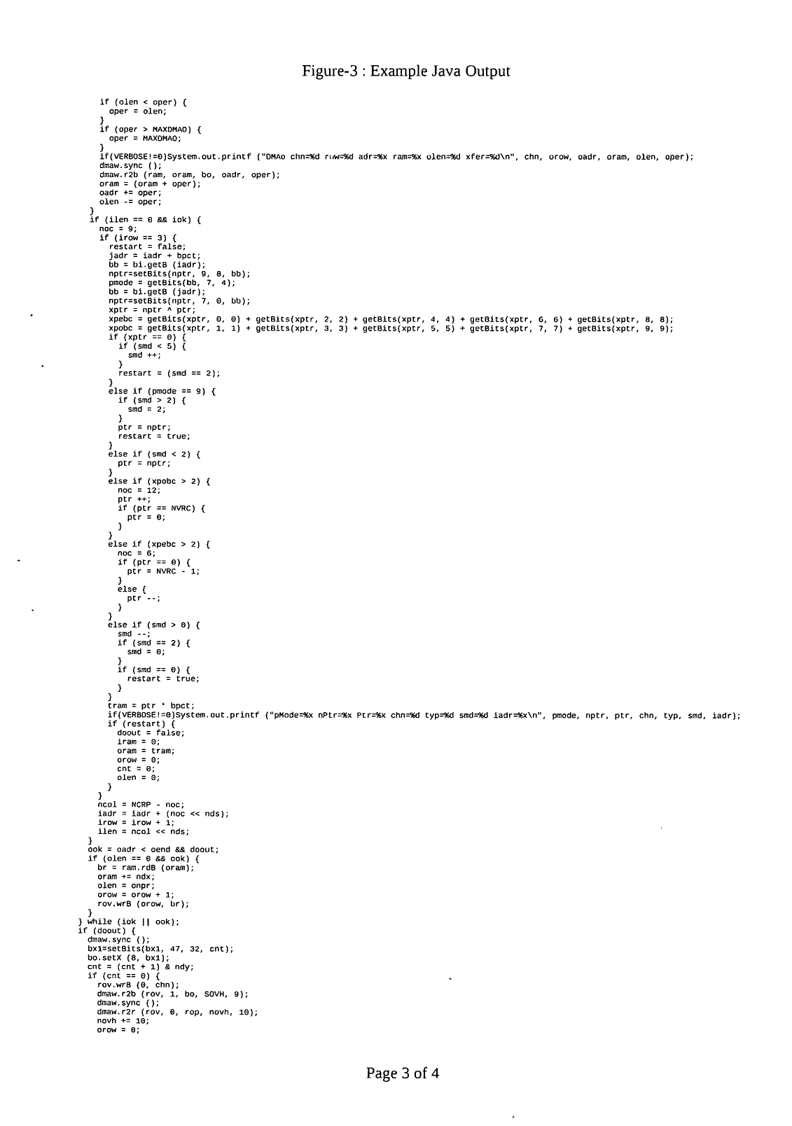

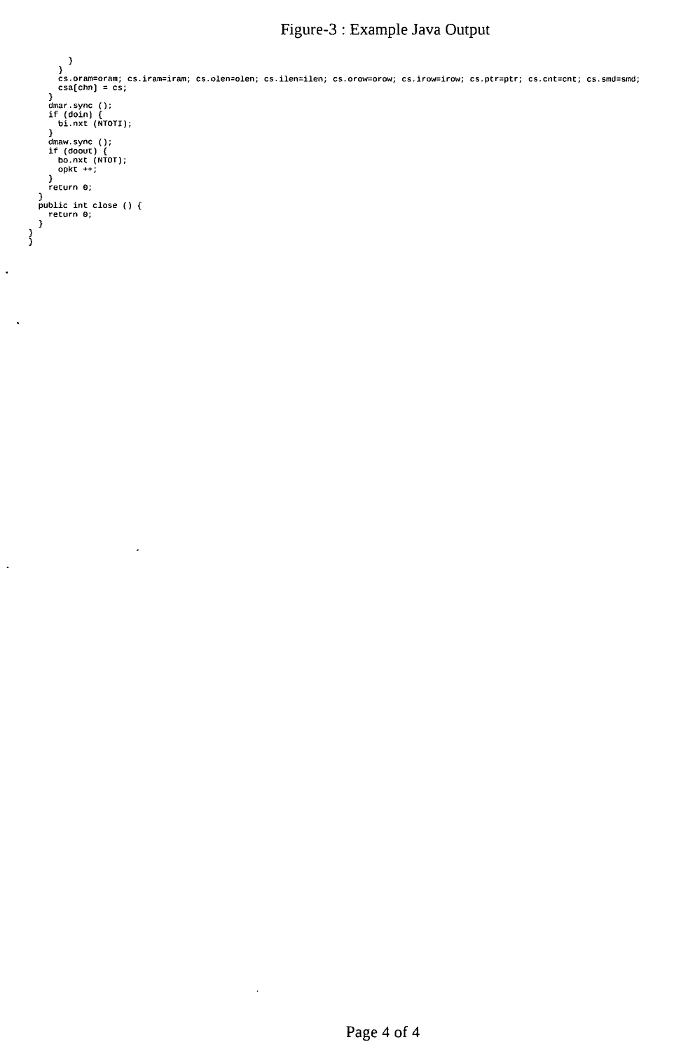

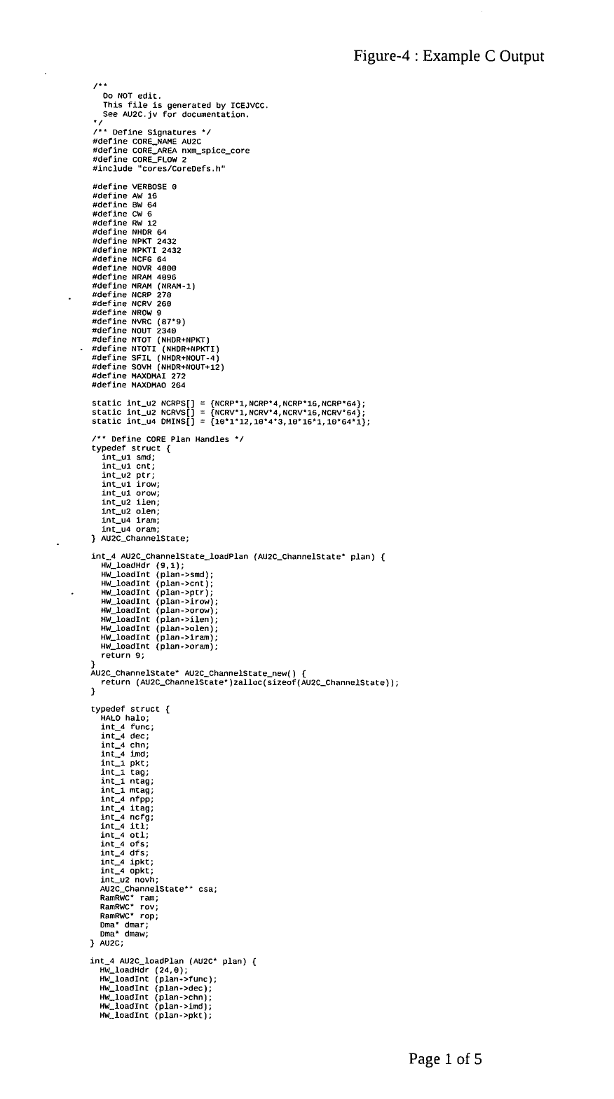

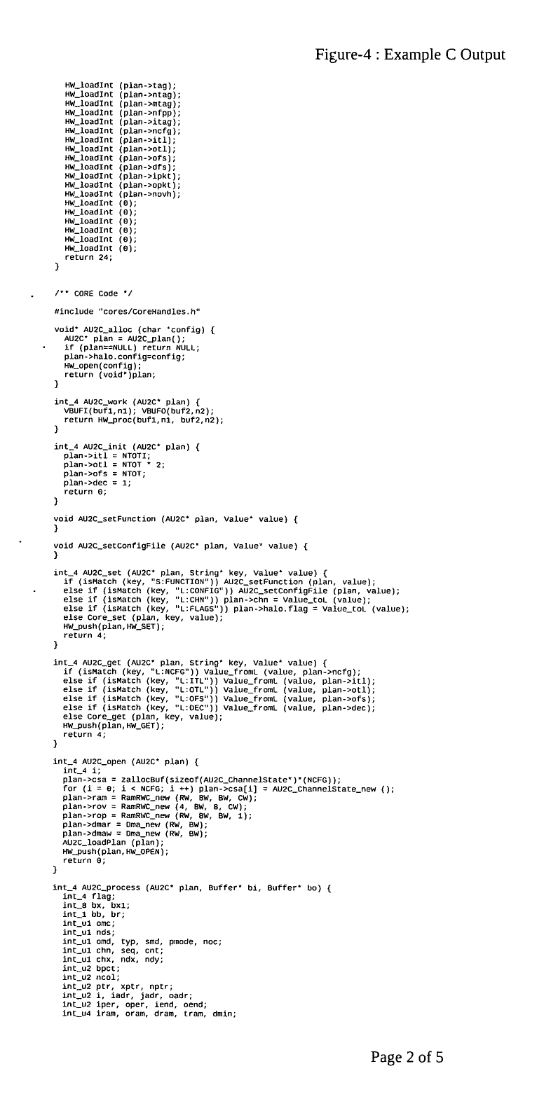

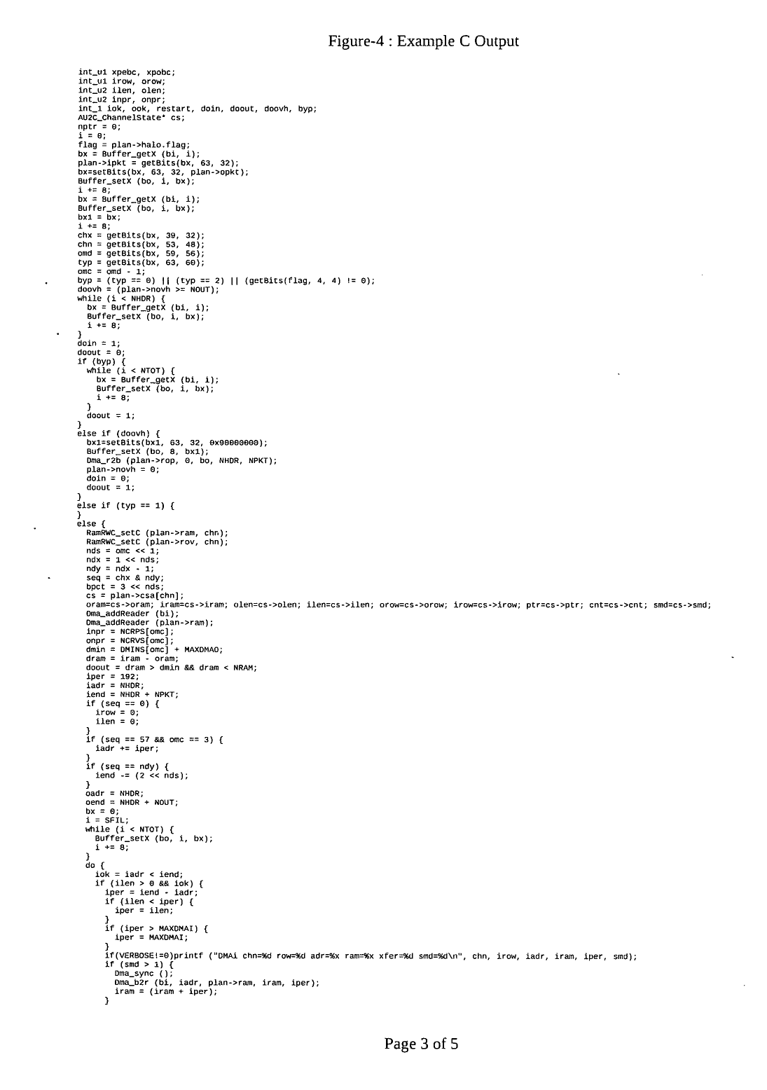

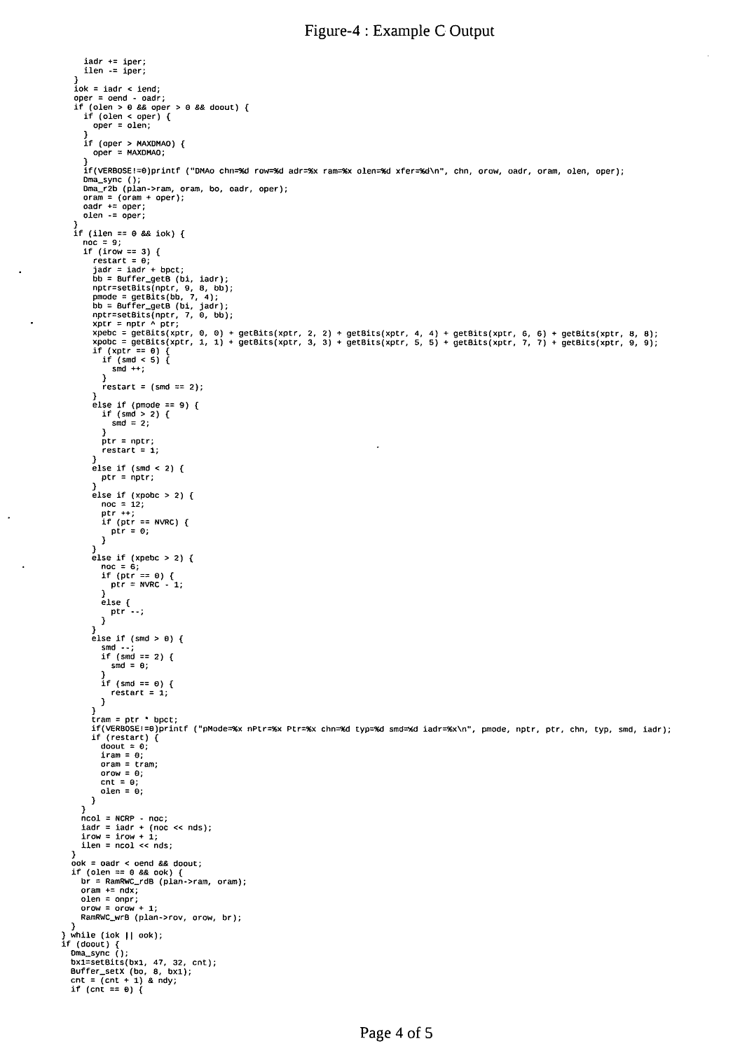

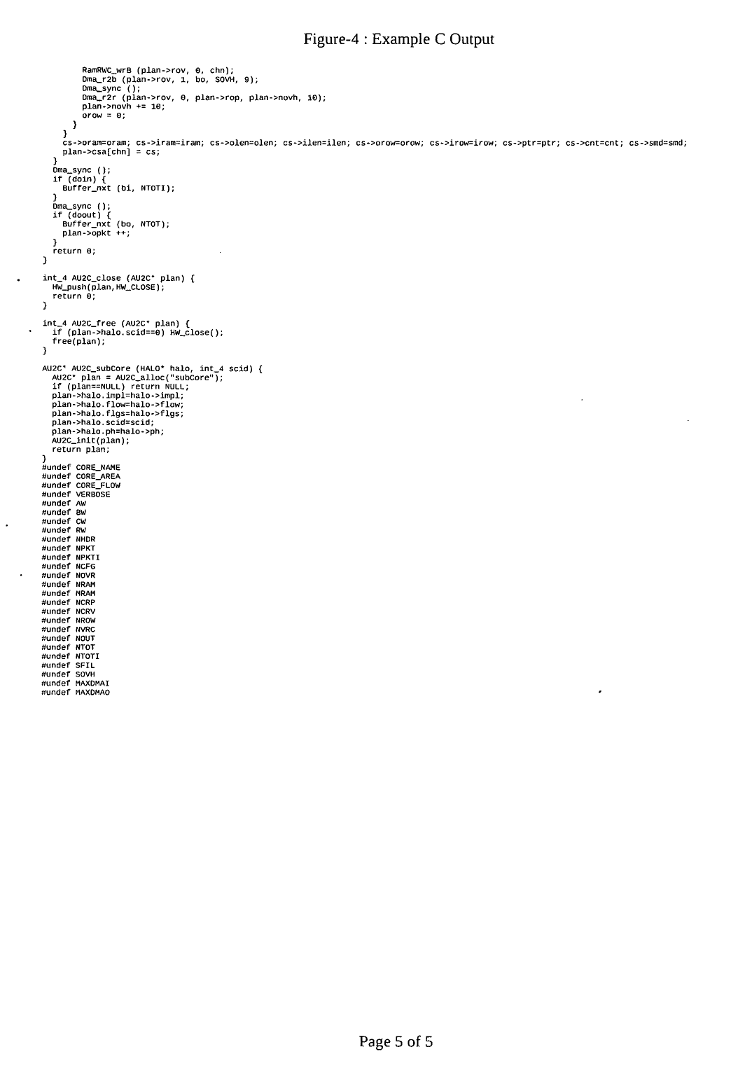

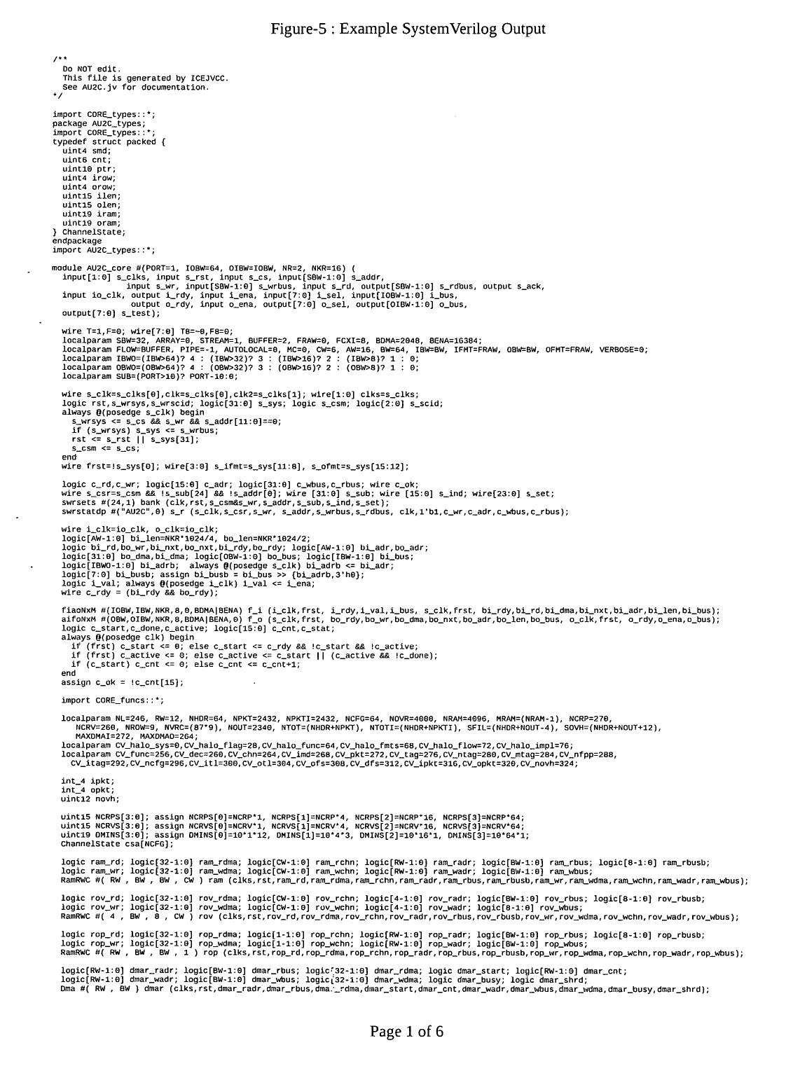

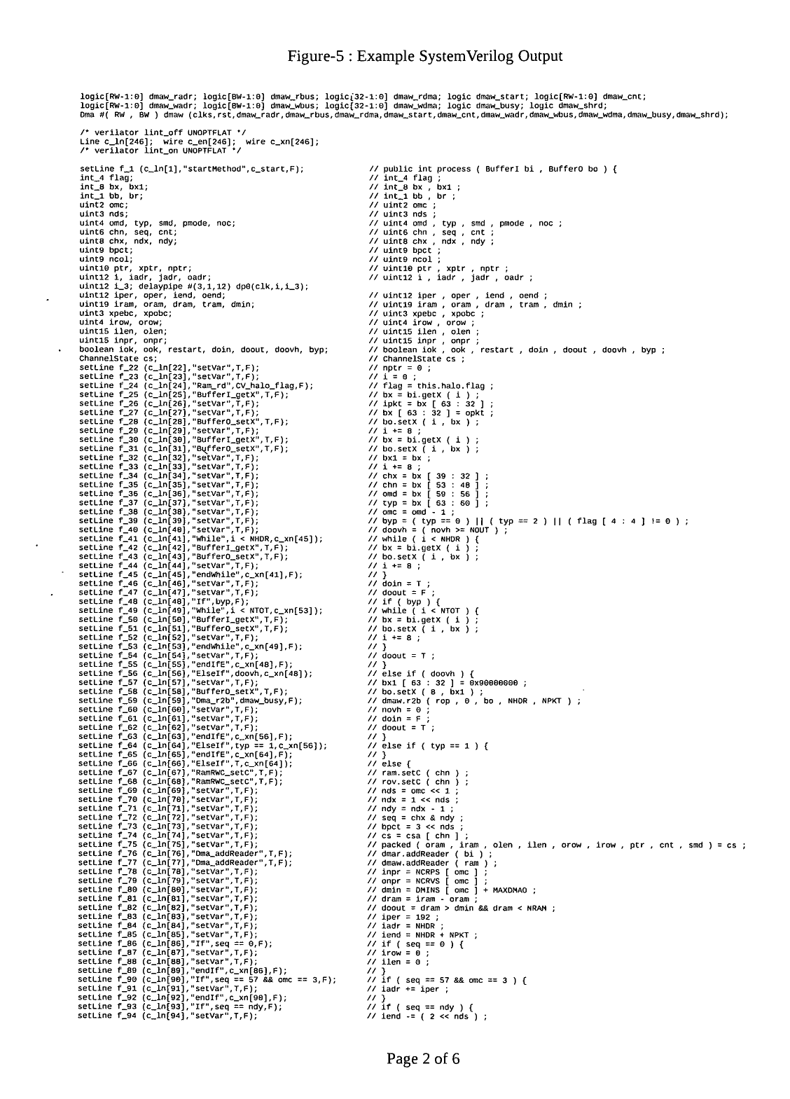

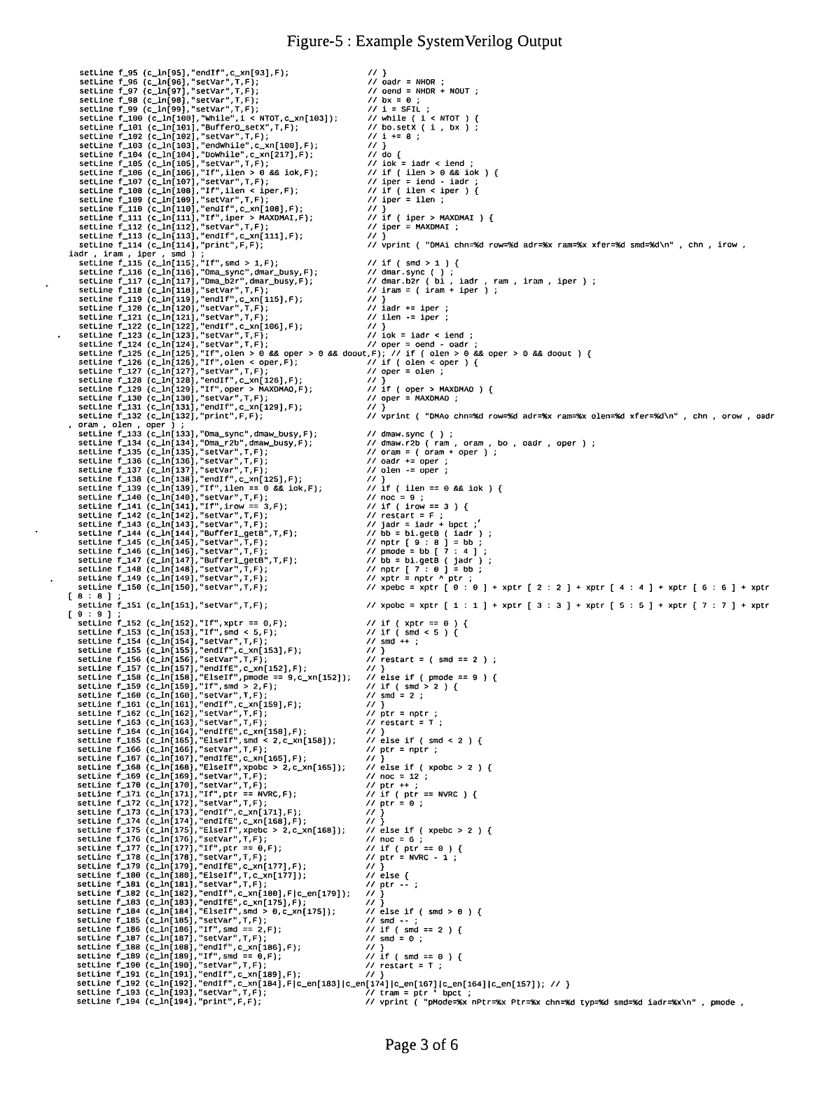

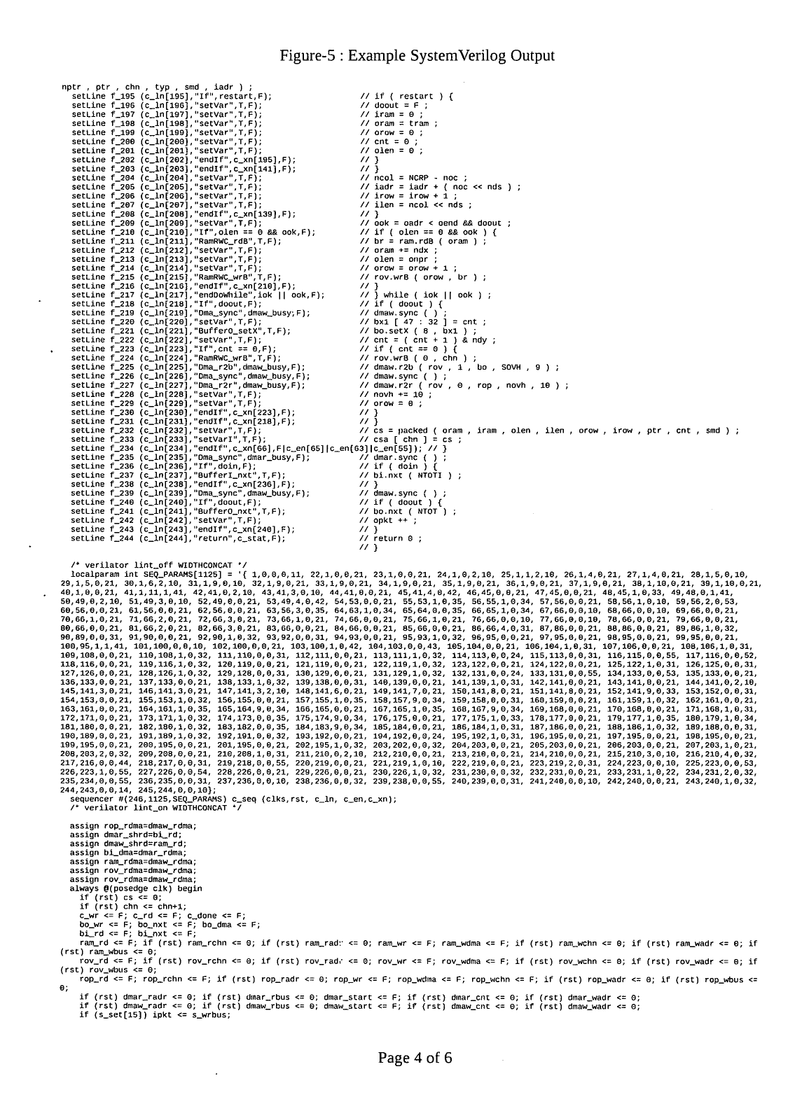

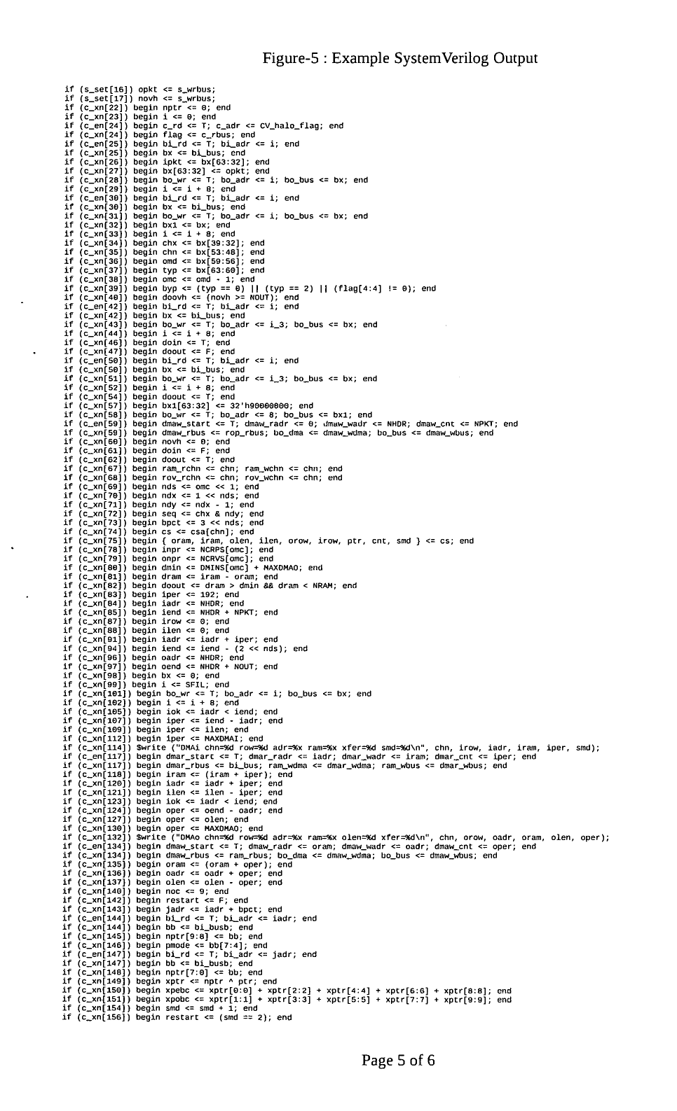

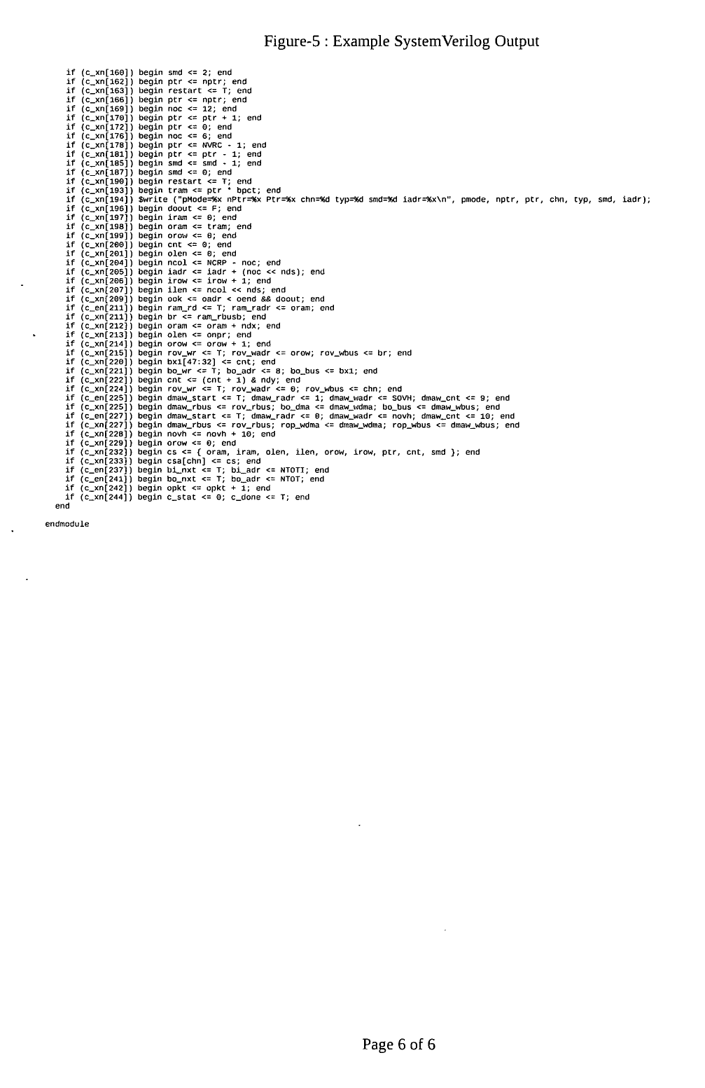

### DETAILED DESCRIPTION

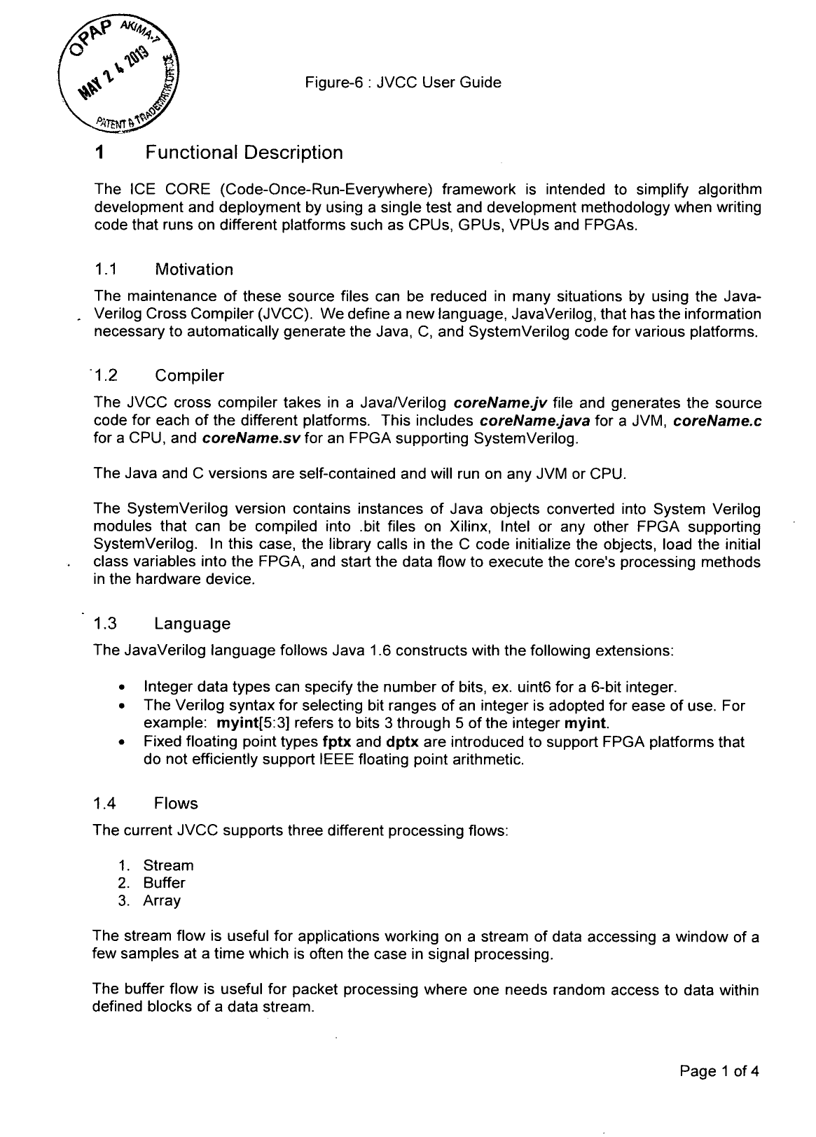

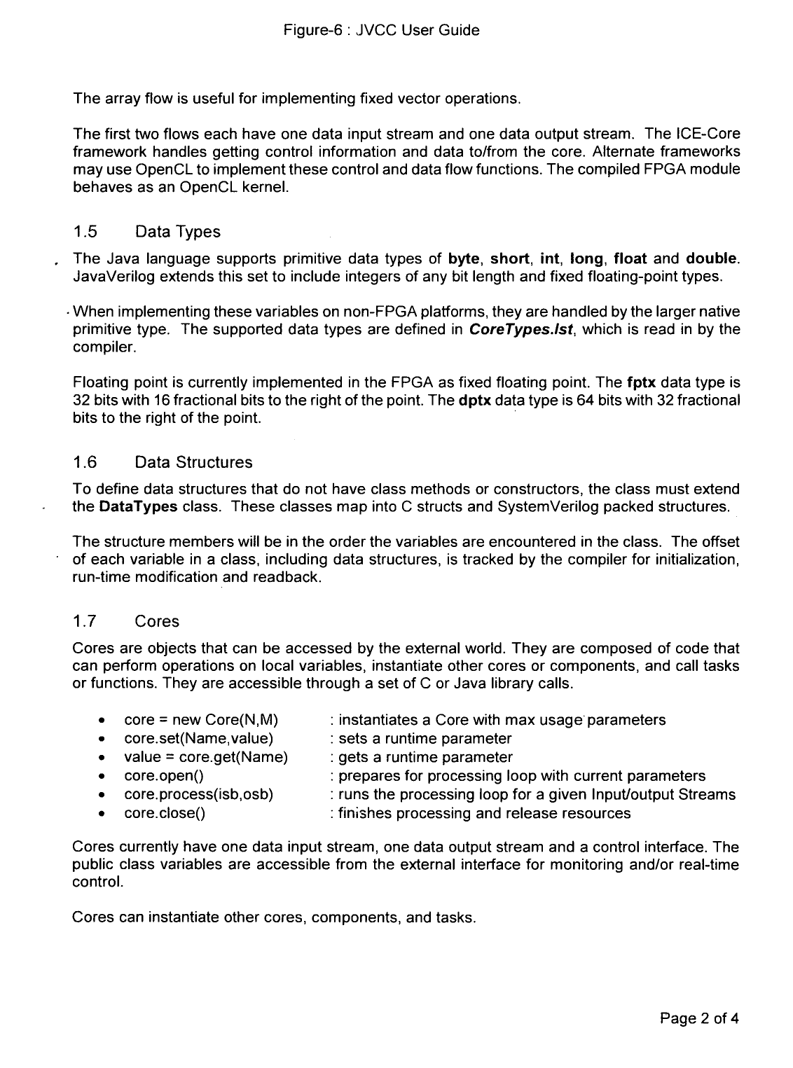

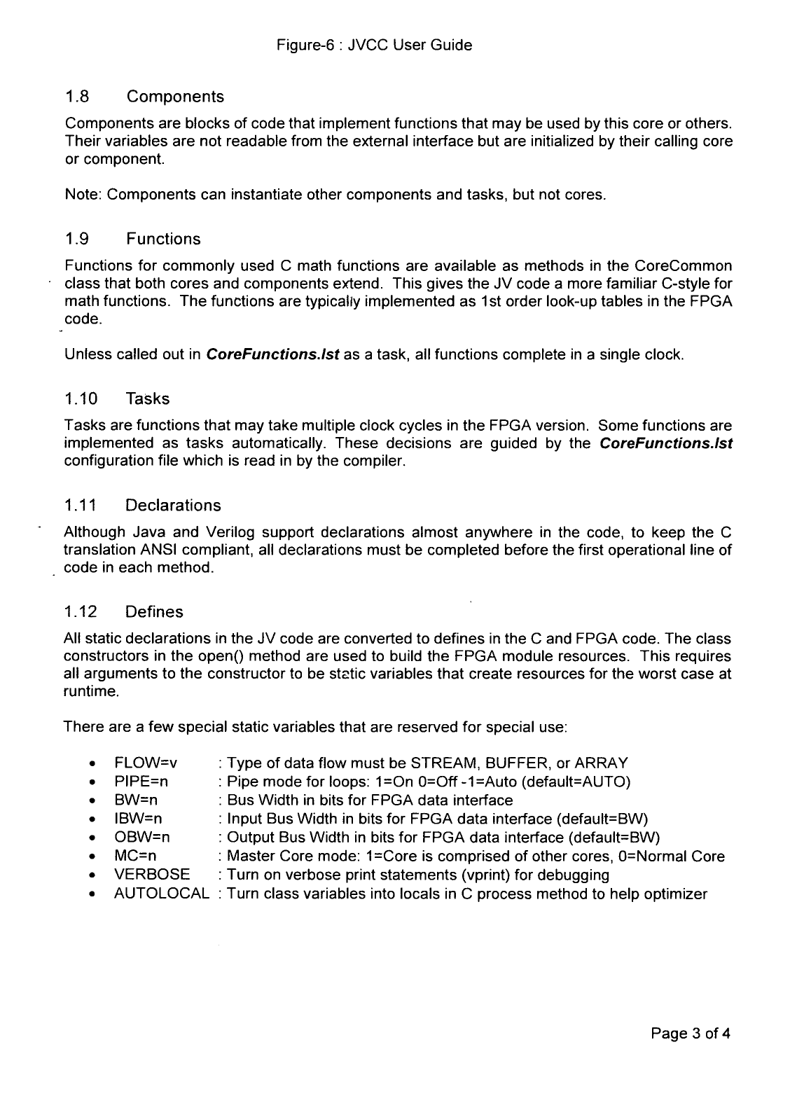

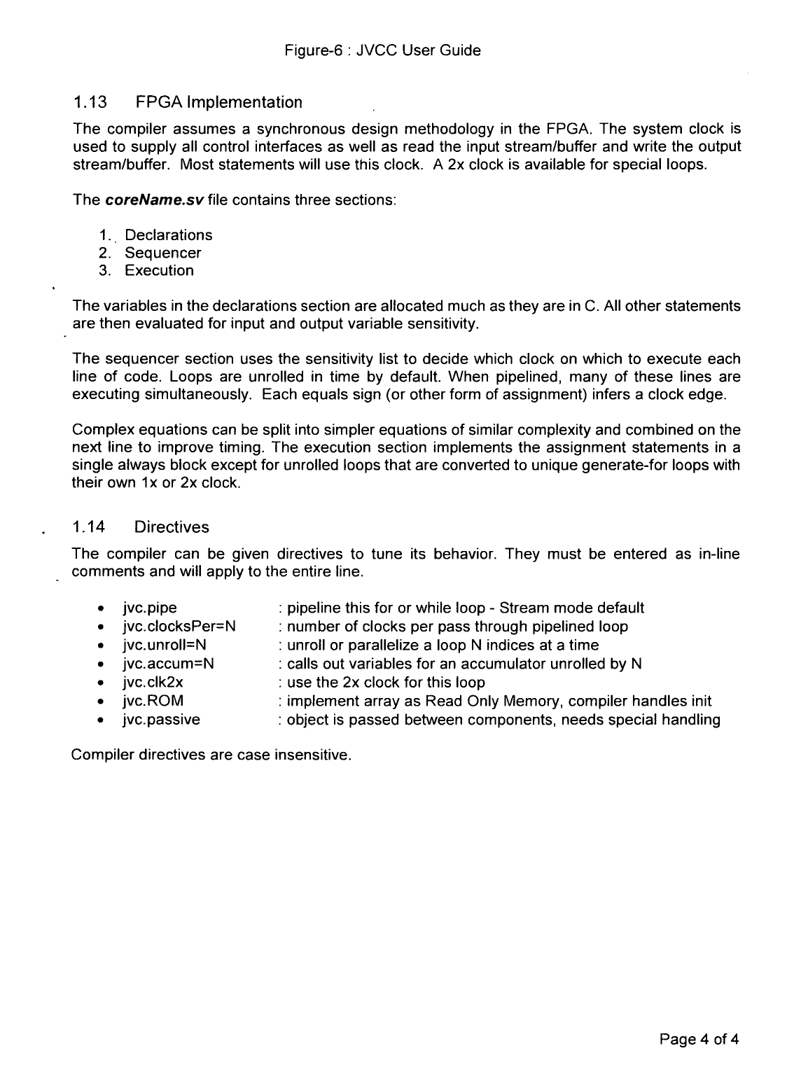

The current version of the code generator is written in Java and in use by a number of projects. The help file for the program is included in FIG. 6.

### 1 Functional Description

The ICE CORE (Code-Once-Run-Everywhere) framework is intended to simplify algorithm development and deployment by using a single test and development methodology when writing code that runs on different platforms such as CPUs, GPUs, VPUs and FPGAs.

### 1.1 Motivation

The maintenance of these source files can be reduced in many situations by using the Java-Verilog Cross Compiler (JVCC). We define a new language, JavaVerilog, that has the information necessary to automatically generate the Java, C, and SystemVerilog code for various platforms.

### 1.2 Compiler

The JVCC cross compiler takes in a Java/Verilog coreName.jv file and generates the source code for each of the different platforms. This includes coreName.java for a JVM, coreName.c for a CPU, and coreName.sv for an FPGA supporting SystemVerilog.

The Java and C versions are self-contained and will run on any JVM or CPU.

The SystemVerilog version contains instances of Java objects converted into System Verilog modules that can be compiled into .bit files on Xilinx, Intel or any other FPGA supporting SystemVerilog. In this case, the library calls in the C code initialize the objects, load the initial class variables into the FPGA, and start the data flow to execute the core's processing methods in the hardware device.

### 1.3 Language

The JavaVerilog language follows Java 1.6 constructs with the following extensions:
Integer data types can specify the number of bits, ex. uint6 for a 6-bit integer.
The Verilog syntax for selecting bit ranges of an integer is adopted for ease of use. For example: myint[5:3] refers to bits 3 through 5 of the integer myint.
Fixed floating point types fptx and dptx are introduced to support FPGA platforms that do not efficiently support IEEE floating point arithmetic.

### 1.4 Flows

The current JVCC supports three different processing flows:
1. Stream
2. Buffer
3. Array

The stream flow is useful for applications working on a stream of data accessing a window of a few samples at a time which is often the case in signal processing.

The buffer flow is useful for packet processing where one needs random access to data within defined blocks of a data stream.

The array flow is useful for implementing fixed vector operations.

The first two flows each have one data input stream and one data output stream. The ICE-Core framework handles getting control information and data to/from the core. Alternate frameworks may use OpenCL to implement these control and data flow functions. The compiled FPGA module behaves as an OpenCL kernel.

### 1.5 Data Types

The Java language supports primitive data types of byte, short, int, long, float and double. JavaVerilog extends this set to include integers of any bit length and fixed floating-point types.

When implementing these variables on non-FPGA platforms, they are handled by the larger native primitive type. The supported data types are defined in CoreTypes.lst, which is read in by the compiler.

Floating point is currently implemented in the FPGA as fixed floating point. The fptx data type is 32 bits with 16 fractional bits to the right of the point. The dptx data type is 64 bits with 32 fractional bits to the right of the point.

### 1.6 Data Structures

To define data structures that do not have class methods or constructors, the class must extend the DataTypes class. These classes map into C structs and SystemVerilog packed structures.

The structure members will be in the order the variables are encountered in the class. The offset of each variable in a class, including data structures, is tracked by the compiler for initialization, run-time modification and readback.

### 1.7 Cores

Cores are objects that can be accessed oy the external world. They are composed of code that can perform operations on local variables, instantiate other cores or components, and call tasks or functions. They are accessible through a set of C or Java library calls.
core=new Core(N,M): instantiates a Core with max usage parameters
core.set(Name,value): sets a runtime parameter
value=core.get(Name): gets a runtime parameter
core.open( ): prepares for processing loop with current parameters
core. process(isb,osb): runs the processing loop for a given Input/output Streams
core. close( ): finishes processing and release resources

Cores currently have one data input stream, one data output stream and a control interface. The public class variables are accessible from the external interface for monitoring and/or real-time control.

Cores can instantiate other cores, components, and tasks.

### 1.8 Components

Components are blocks of code that implement functions that may be used by this core or others. Their variables are not readable from the external interface but are initialized by their calling core or component.

Note: Components can instantiate other components and tasks, but not cores.

### 1.9 Functions

Functions for commonly used C math functions are available as methods in the CoreCommon class that both cores and components extend. This gives the JV code a more familiar C-style for math functions. The functions are typically implemented as 1st order look-up tables in the FPGA code.

Unless called out in CoreFunctions.lst as a task, all functions complete in a single clock.

### 1.10 Tasks

Tasks are functions that may take multiple clock cycles in the FPGA version. Some functions are implemented as tasks automatically. These decisions are guided by the CoreFunctions.lst configuration file which is read in by the compiler.

### 1.11 Declarations

Although Java and Verilog support declarations almost anywhere in the code, to keep the C translation ANSI compliant, all declarations must be completed before the first operational line of code in each method.

### 1.12 Defines

All static declarations in the JV code are converted to defines in the C and FPGA code. The class constructors in the open( ) method are used to build the FPGA module resources. This requires all arguments to the constructor to be static variables that create resources for the worst case at runtime.

There are a few special static variables that are reserved for special use:
FLOW=v: Type of data flow must be STREAM, BUFFER, or ARRAY
PIPE=n: Pipe mode for loops: 1=On 0=Off−1=Auto (default=AUTO)
BW=n: Bus Width in bits for FPGA data interface
IBW=n: Input Bus Width in bits for FPGA data interface (default=BW)
OBW=n: Output Bus Width in bits for FPGA data interface (default=BW)
MC=n: Master Core mode: 1=Core is comprised of other cores, 0=Normal Core
VERBOSE: Turn on verbose print statements (vprint) for debugging
AUTOLOCAL: Turn class variables into locals in C process method to help optimizer

### 1.13 FPGA Implementation

The compiler assumes a synchronous design methodology in the FPGA. The system clock is used to supply all control interfaces as well as read the input stream/buffer and write the output stream/buffer. Most statements will use this clock. A 2× clock is available for special loops.
The coreName.sv file contains three sections:
1. Declarations
2. Sequencer
3. Execution

The variables in the declarations section are allocated much as they are in C. All other statements are then evaluated for input and output variable sensitivity.

The sequencer section uses the sensitivity list to decide which clock on which to execute each line of code. Loops are unrolled in time by default. When pipelined, many of these lines are executing simultaneously. Each equals sign (or other form of assignment) infers a clock edge.

Complex equations can be split into simpler equations of similar complexity and combined on the next line to improve timing. The execution section implements the assignment statements in a single always block except for unrolled loops that are converted to unique generate-for loops with their own 1× or 2× clock.

### 1.14 Directives

The compiler can be given directives to tune its behavior. They must be entered as in-line comments and will apply to the entire line.
jvc.pipe: pipeline this for or while loop—Stream mode default
jvc.clocksPer=N: number of clocks per pass through pipelined loop
jvc.unroll=N: unroll or parallelize a loop N indices at a time
jvc.accum=N: calls out variables for an accumulator unrolled by N
jvc.clk2×: use the 2× clock for this loop
jvc.ROM: implement array as Read Only Memory, compiler handles init
jvc. passive: object is passed between components, needs special handling

Compiler directives are case insensitive.

### Privacy Act Statement

The Privacy Act of 1974 (P.L. 93-579) requires that you be given certain information in connection with your submission of the attached form related to a patent application or patent. Accordingly, pursuant to the requirements of the Act, please be advised that: (1) the general authority for the collection of this information is 35 U.S.C. 2(b)(2); (2) furnishing of the information solicited is voluntary; and (3) the principal purpose for which the information is used by the U.S. Patent and Trademark Office is to process and/or examine your submission related to a patent application or patent. If you do not furnish the requested information, the U.S. Patent and Trademark Office may not be able to process and/or examine your submission, which may result in termination of proceedings or abandonment of the application or expiration of the patent.

The information provided by you in this form will be subject to the following routine uses:
1. The information on this form will be treated confidentially to the extent allowed under the Freedom of Information Act (5 U.S.C. 552) and the Privacy Act (5 U.S.C 552a). Records from this system of records may be disclosed to the Department of Justice to determine whether disclosure of these records is required by the Freedom of Information Act.
2. A record from this system of records may be disclosed, as a routine use, in the course of presenting evidence to a court, magistrate, or administrative tribunal, including disclosures to opposing counsel in the course of settlement negotiations.
3. A record in this system of records may be disclosed, as a routine use, to a Member of Congress submitting a request involving an individual, to whom the record pertains, when the individual has requested assistance from the Member with respect to the subject matter of the record.
4. A record in this system of records may be disclosed, as a routine use, to a contractor of the Agency having need for the information in order to perform a contract. Recipients of information shall be required to comply with the requirements of the Privacy Act of 1974, as amended, pursuant to 5 U.S.C. 552a(m).
5. A record related to an International Application filed under the Patent Cooperation Treaty in this system of records may be disclosed, as a routine use, to the International Bureau of the World Intellectual Property Organization, pursuant to the Patent Cooperation Treaty.
6. A record in this system of records may be disclosed, as a routine use, to another federal agency for purposes of National Security review (35 U.S.C. 181) and for review pursuant to the Atomic Energy Act (42 U.S.C. 218(c)).
7. A record from this system of records may be disclosed, as a routine use, to the Administrator, General Services, or his/her designee, daring an inspection of records conducted by GSA as part of that agency's responsibility to recommend improvements in records management practices and programs, under authority of 44 U.S.C. 2904 and 2906. Such disclosure shall be made in accordance with the GSA regulations governing inspection of records for this purpose, and any other relevant (i.e., GSA or Commerce) directive. Such disclosure shall not be used to make determinations about individuals.
8. A record from this system of records may be disclosed, as a routine use, to the public after either publication of the application pursuant to 35 U.S.C. 122(b) or issuance of a patent pursuant to 35 U.S.C. 151. Further, a record may be disclosed, subject to the limitations of 37 CFR 1.14, as a routine use, to the public if the record was filed in an application which became abandoned or in which the proceedings were terminated and which application is referenced by either a published application, an application open to public inspection or an issued patent.
9. A record from this system of records may be disclosed, as a routine use, to a Federal, State, or local law enforcement agency, if the USPTO becomes aware of a violation or potential violation of law or regulation.

What is claimed is:

1. A method for developing a processing algorithm on multiple hardware platforms from a common high-level code source, the method comprising:
reading a source file conforming to the JavaVerilog language syntax defining the processing algorithm, wherein: the JavaVerilog language syntax conforms to Java 1.6 with the addition of SystemVerilog data types and SystemVerilog bit manipulation syntax;
reading configuration files defining data types, math functions, and
optimization preferences;
producing a pure Java implementation for execution on a JVM;
producing a pure C implementation for execution on a CPU;
producing a pure C implementation for controlling an accelerator platform; and
producing a pure SystemVerilog implementation for execution on an FPGA accelerator platform, wherein: the SystemVerilog implementation includes object instantiation and initialization, control flow sequencing, math function implementation, instruction pipelining, loop unrolling, and clock doubling.
